(19) United States
(12) Patent Application Publication
(10) Pub. No.: US 2015/0086187 A1
(43) Pub. Date: Mar. 26, 2015

(54) Photographic Film Holder for Tablet Device

(71) Applicant: Troy Tauzin, Baton Rouge, LA (US)

(72) Inventor: Troy Tauzin, Baton Rouge, LA (US)

(21) Appl. No.: 14/038,474

(22) Filed: Sep. 26, 2013

(51) Int. Cl. G03B 17/56

(52) U.S. Cl. CPC G03B 17/568
USPC 396/5

(57) ABSTRACT

A photographic film holder is provided, comprising a masking plate having an internal surface, an external surface, and a film viewing aperture. The masking plate includes a light baffle having sidewalls extending from the external surface and surrounding the film viewing aperture. A film slot is formed into the sidewall and is adapted to receive and retain a photographic film, such as a 35 mm slide or film negative. The film holder includes a retention member extending from the masking plate, which is adapted to engage a light emitting device, such as a tablet device or smart phone, and retain the masking plate in a fixed position relative to the tablet. Once the film holder is in position, light from the tablet illuminates the content of the film, and a duplicate image of the film may be captured using a digital camera.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field of the Invention

The present invention relates to devices used to hold photographic slide and film negatives for digital imaging using a light box, and more particularly to such devices that can be attached to portable tablets, monitors, and similar displays.

2. Description of Related Art

Prior to the advent of digital imaging, conventional photographic devices produced images on slides and film of various sizes. As a result, consumers retain vast collections of such slides, photographs, and film negatives. In the case of developed photographs on paper, such photographs can be easily scanned on modern digital scanners to produce high quality duplications. However, in the case of film negatives and slides, one must place the film negative or slide on a light table, or otherwise illuminate the image, so that it can be photographed using a digital camera equipped with a macro lens or using a macro setting.

One method of capturing digital images of slides and film negatives involves a slide duplicator, or “duper”, which provides a relatively inexpensive option for digitizing slides. A slide duplicator attaches to a single lens reflex (SLR) or digital single lens reflex (DSLR) camera in place of the lens, typically employing an adapter ring. The opposite end of the slide duplicator is a sliding gate that holds one or more slides. The duplicator also has an internal lens with a fixed aperture and focusing distance that focuses the slide's image onto the DSLR's imaging plane so that a digital image of the slide can be captured. Thereafter, the image can be copied, stored, and displayed as a digital copy on smart phones, computers, and other common devices as is well known.

While slide duplicators are inexpensive and easy to use, they cannot produce the digital quality that can be achieved from a flatbed or film scanner. Furthermore, some unavoidable cropping of the image may be required. And finally, some digital cameras do not offer the dynamic range (the amount of gradation between light and dark in the photo) of a scanner, which can affect attributes of the photograph, including shadow detail, color depth, and related image quality parameters.

Flatbed scanners usually provide higher quality digital reproduction of slides than slide duplicators, especially scans that can be accomplished at resolutions exceeding about 2400 dpi. Many flatbed scanners require an extra transparency adapter attachment for scanning the slides, which may come with the scanner or be purchased separately. Scanning software installed on the connected computer assists the user in controlling scan quality and other image attributes.

Finally, from an image quality standpoint, the method often recognized as producing the best digital reproductions for slides is a high resolution dedicated film/slide scanner. However, such devices are fairly expensive, so this is not always an option unless duplication of many slides, i.e. hundreds or thousands of slides, is required. Persons must generally hire a third-party commercial vendor that owns such a scanner, which typically means that the per-slide costs are high. Also, if the content of the slides is sensitive, confidential, or highly valuable, the owner of the slides may have concerns over the security of the images when third parties have access to such images.

Therefore, for persons who have slides requiring digital imaging on an infrequent basis, there is a need in the industry for an inexpensive, quick, and easy method to convert the slides to electronic images. In some cases, a traditional light table may be used to illuminate the slide, and a digital camera can be used to capture the image. But, most persons do not own light tables, and finding one can be difficult. However, in recent years, the popularity and availability of tablet devices and smart phones has increased to the point where access is almost universal. These devices, by virtue of their display technology, can actually serve as a make-shift light table, provided that the illumination intensity (typically measured in lumens) is enough to produce a clear image for duplication. For example, a tablet device, such as the iPad produced by Apple, can be set to display a white image which provides the maximum lumens. While such a display is helpful, there are a number of problems that must be overcome. First, placement of the slide on the tablet display must be done when the tablet is in a horizontal orientation, otherwise the slide would move away from a fixed position when the tablet is tilted. Tape can be used to secure the slide to the display, but that is an inconvenient and inelegant solution which fails to provide repeatability for multiple slides. Second, the light displayed around the outer edges of the slide creates too much extraneous light for high quality duplication, and there is no simple way to mask the extra light from the tablet display prior to capturing the image.

For these reasons, the best solution would be a device for holding a slide in a fixed position relative to the tablet display, wherein the device is easily attached to the tablet device, and which also provides suitable masking of the slide to enable the highest quality image to be made by a digital camera.

### SUMMARY OF THE INVENTION

Therefore, a photographic film holder is provided, comprising a masking plate having an internal surface, an external surface, and a film viewing aperture; a light baffle having sidewalls extending from the external surface and surrounding the film viewing aperture, wherein at least one sidewall includes a slot adapted to receive and retain a photographic film; a retention member extending from the masking plate adapted to engage a light emitting device and retain the masking plate in a fixed position relative to the light emitting device.

In a preferred embodiment, the internal surface of the masking plate is adapted to contact a display surface of the light emitting device.

In another embodiment, the film viewing aperture is sized to permit visual perception of all photographic content of the photographic film.

In another embodiment, the side walls of the light baffle extend a selected distance from the external surface of the masking plate sufficient to block extraneous light from the photographic film. Optionally, the side walls define a rectangular volume in front of the aperture.

More preferably, the slot and side walls are adapted to retain the photographic film in a predetermined position and orientation relative to the aperture.

In an alternative embodiment, the retention member is a clip-type fastener extending across an upper edge of the masking member.

In a more preferred embodiment, the masking member, the light baffle, and the retention member are constructed from a plastic material.

The above and other objects and features of the present invention will become apparent from the drawings, the description given herein, and the appended claims.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 illustrates a perspective view of a preferred embodiment of the present invention as mounted on a portable tablet device.

FIG. 2 illustrates a typical photographic slide which can be viewed using the invention of FIG. 1.

FIG. 3 illustrates a front view of the invention of FIG. 1.

FIG. 4 illustrates a side view of the invention of FIG. 1, and further depicting a possible position of a camera to capture an image.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

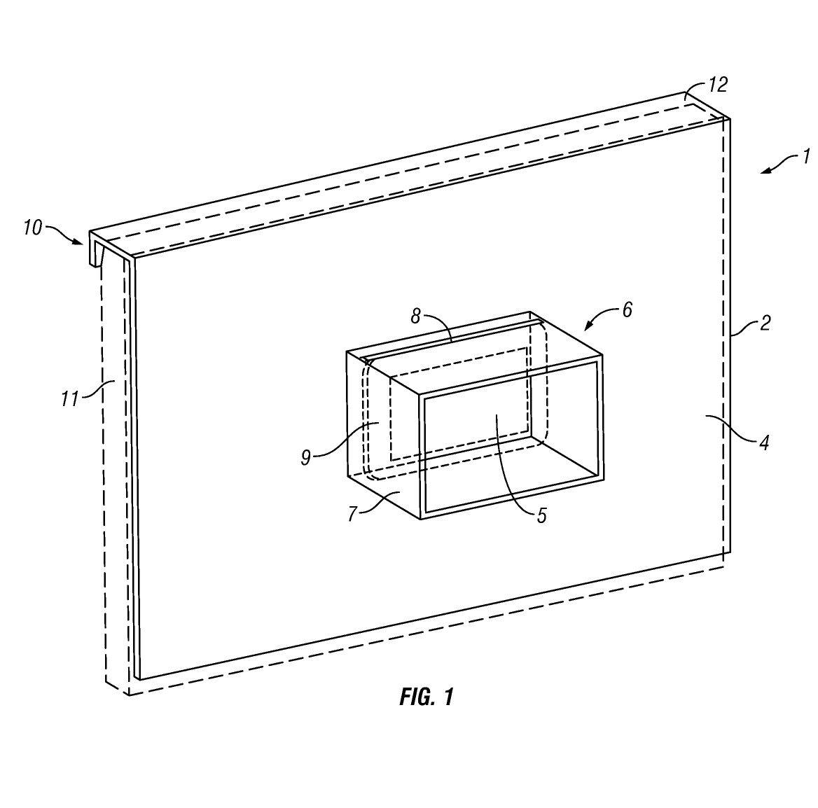

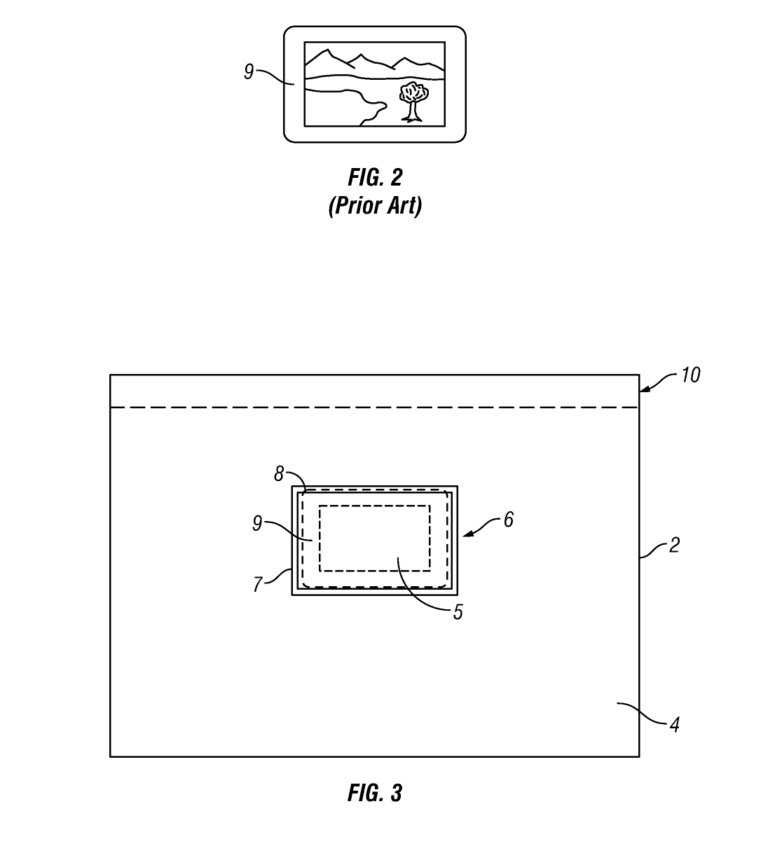

Referring now to the drawings, and in particular FIG. 1, a photographic film holder 1 is shown to generally comprise a masking plate 2 having an internal surface 3, an external surface 4, and a film viewing aperture 5. A light baffle 6 having sidewalls 7 extends from the external surface 4 and surrounds the film viewing aperture 5. At least one sidewall 7 includes a slot 8 adapted to receive and retain a photographic film 9. For the purposes of this invention, a photographic film 9 may be any slide (such as 35 mm shown in FIG. 2, or other size) or any film negative of any size. As will be understood, the relative dimensions of the aperture 5, light baffle 6, and side walls 7 could be scaled to accommodate the corresponding size of the photographic film 9 as needed.

A retention member 10 extends from the masking plate 2 adapted to engage a light emitting device 11 and retain the masking plate 2 in a fixed position relative to the light emitting device 11. For the purposes of this invention, a light emitting device 11 may include any portable device which provides illumination sufficient to enable visual perception of the photographic content of the photographic film 9. This may be a portable tablet device, smart phone, or similar device having a display that can be controlled to emit a uniform bright white illumination.

In a preferred embodiment, the internal surface 3 of the masking plate 2 is adapted to contact a display surface of the light emitting device 11. In another embodiment, the film viewing aperture 5 is sized to permit visual perception of all photographic content of the photographic film 9.

Preferably, the side walls 7 of the light baffle 6 extend a selected distance from the external surface 4 of the masking plate 2 sufficient to block extraneous light from the photographic film 9. In most case, the selected distance may range from about one inch (1″) to about three inches (3″). Optionally, the side walls 7 define a rectangular volume in front of the aperture 5, although other shapes may also be suitable if the entire photographic content of the film 9 remains visible.

More preferably, the slot 8 and side walls 7 are adapted to retain the photographic film 9 in a predetermined position and orientation relative to the aperture 5. For example, when using a DSLR camera 13 to capture the digital image of the photographic film 9, the camera 13 is often placed in a fixed position relative to the light emitting device 11. Therefore, each successive photographic film 9 to be duplicated should always reside in the same position and orientation for consistent duplication.

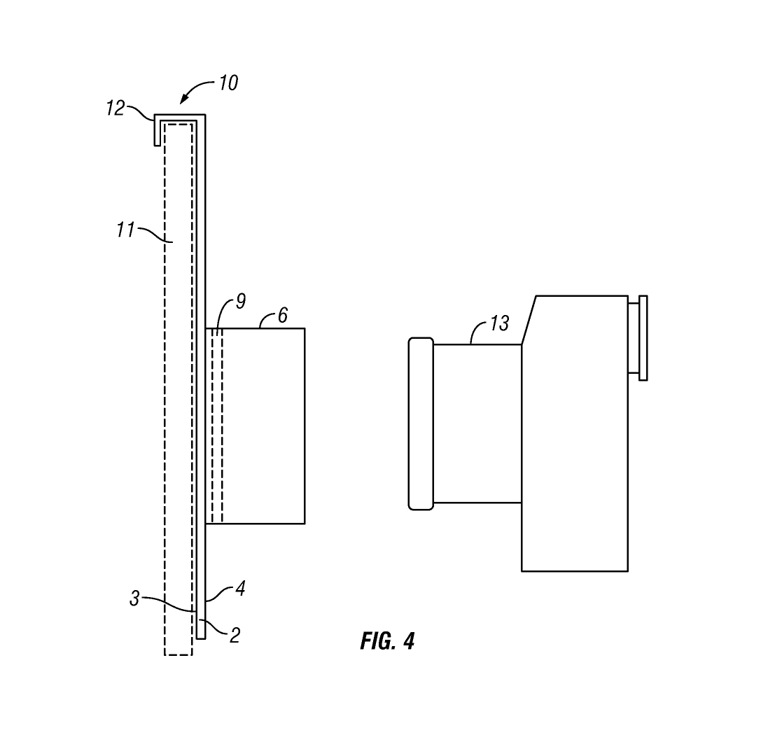

In an alternative embodiment, the retention member 10 is a clip-type fastener extending across an upper edge of the masking member 2. In the embodiment shown in FIGS. 1, 3, and 4, the retention member 10 comprises an L-shaped clip 12 extending from the masking member 2. However, the precise structure of the retention member can be any device which allows the film holder to hang from the lighting device employed, which will typically be a tablet device such as an iPad.

In a more preferred embodiment, the masking member 2, the light baffle 6, and the retention member 10 are constructed from a durable plastic material, such as ABS (acrylonitrile butadiene styrene) plastic.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only, and the scope of the present invention is to be limited only by the following claims.

The invention claimed is:

1. A photographic film holder, comprising:
a masking plate having an internal surface, an external surface, and a film viewing aperture;
a light baffle having sidewalls extending from the external surface and surrounding the film viewing aperture, wherein at least one sidewall includes a slot adapted to receive and retain a photographic film;
a retention member extending from the masking plate adapted to engage a light emitting device and retain the masking plate in a fixed position relative to the light emitting device.

2. The holder of claim 1, wherein the internal surface of the masking plate is adapted to contact a display surface of the light emitting device.

3. The holder of claim 1, wherein the film viewing aperture is sized to permit visual perception of all photographic content of the photographic film.

4. The holder of claim 1, wherein the side walls of the light baffle extend a selected distance from the external surface of the masking plate sufficient to block extraneous light from the photographic film.

5. The holder of claim 1, wherein the slot and side walls are adapted to retain the photographic film in a predetermined position and orientation relative to the aperture.

6. The holder of claim 1, wherein the retention member is a clip-type fastener extending across an upper edge of the masking member.

7. The holder of claim 4, wherein the side walls define a rectangular volume in front of the aperture.

8. The holder of claim 1, wherein the masking member, the light baffle, and the retention member are constructed from a plastic material.
